(19) United States
(12) Patent Application Publication
(10) Pub. No.: US 2006/0292285 A1
(43) Pub. Date: Dec. 28, 2006

(54) Method of providing a protein-rich composition for a canine

(76) Inventor: Eileen H. Clay, North Las Vegas, NV (US)

Correspondence Address: WEISS & MOY PC, 4204 NORTH BROWN AVENUE, SCOTTSDALE, AZ, 85251, US

(21) Appl. No.: 11/167,899

(22) Filed: Jun. 27, 2005

(51) Int. Cl. A23L 1/31

(52) U.S. Cl. 426/641

(57) ABSTRACT

A method for delivering a protein-rich, chip-like treat to a canine. A protein rich chip is, in one embodiment, baked from a plurality of ingredients that includes salmon and/or cod as the protein-source. Additional ingredients, which are preferably organic, may include whole wheat flour, brown rice flour, tomato paste, canola oil, green tea, and a lemon.

### FIELD OF THE INVENTION

The present invention relates to canine nutrition and, more particularly, to a method for delivering a thin, chip-like, protein rich food composition to a canine.

### BACKGROUND OF THE INVENTION

Dog snacks and treats of various kinds are known. Very typically, these are intended to appeal to a dog's instinct to chew. As a consequence, they will generally come in a hard, bone-type of form, or in a chewy, jerky form. In either configuration, they are intended to provide a dog with chewing pleasure and, often, a pleasing taste.

However, dogs are not always interested in snacks that require substantial chewing effort. There are times when dogs are simply interested in consuming a tasty snack. From the point of view of a canine owner, there will be a desire to ensure that a beloved pet is eating nutritionally and not simply that the dog's chewing muscles are receiving a good workout.

The present invention is directed to a composition and method for a protein-rich snack for a canine, which is delivered in an easily consumable, chip-like form.

### SUMMARY OF THE INVENTION

In accordance with one embodiment of the present invention, a method for providing a protein-rich food for a canine is provided. The method comprises forming a protein-rich food item, in combination with other ingredients, into a chip; packaging a plurality of the chips in a container; and providing at least one of the chips, from the container, to a canine.

In accordance with another embodiment of the present invention a method for providing a protein-rich food for a canine is provided. The method comprises forming a protein-rich food item, in combination with other ingredients, into a chip; wherein the protein-rich food item is at least one of salmon and cod; wherein the other ingredients are at least one of the following: flour; tomato paste, oil, green tea, lemon; packaging a plurality of the chips in a container; and providing at least one of the chips, from the container, to a canine.

In accordance with a further embodiment of the present invention, a method for providing a protein-rich food for a canine is provided. The method comprises forming a protein-rich food item, in combination with other ingredients, into a chip; wherein the protein-rich food item is at least one of salmon and cod; wherein the other ingredients include each of the following: flour; tomato paste, oil, green tea, lemon; wherein each of these other ingredients is organic; packaging a plurality of the chips in a container; wherein the container is one of a bag and a canister; and providing at least one of the chips, from the container, to a canine.

### BRIEF DESCRIPTION OF THE DRAWINGS

FIG. 1 is a perspective view of a protein-rich, chip-like, canine treat formed in accordance with an embodiment of the present invention.

FIG. 2 is a perspective view of a bag-type of container for a plurality of chip-like canine treats.

FIG. 3 is a perspective view of a canister-type of container for a plurality of chip-like canine treats.

### DETAILED DESCRIPTION OF THE PREFERRED EMBODIMENTS

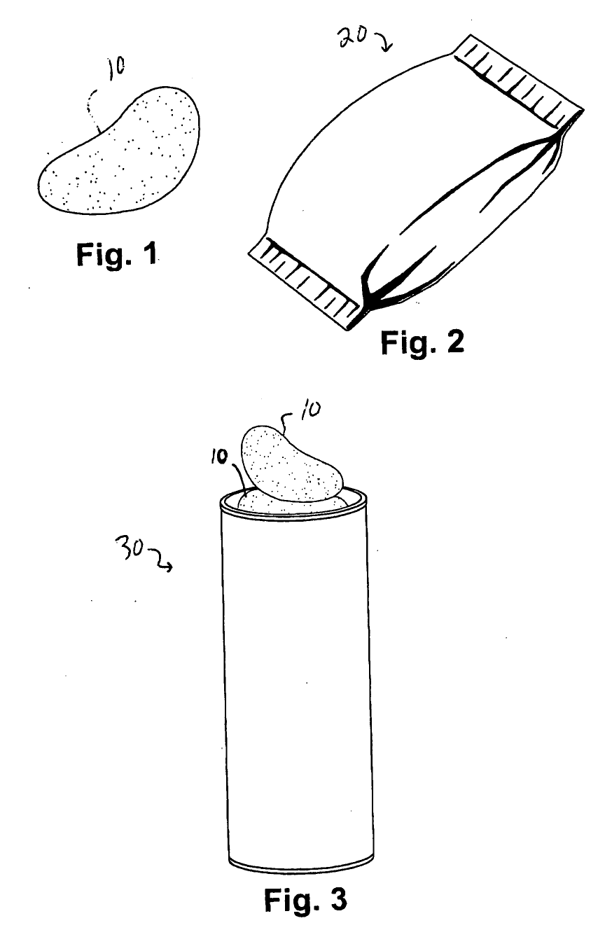

Referring first to FIG. 1, a chip-like treat 10 (“chip 10”) formed in accordance with an embodiment of the present invention is shown. The thickness of the chip 10 should be substantially that of a potato chip. As shown in FIG. 2, a plurality of chips 10 (not shown) may be packaged in a bag 20. As shown in FIG. 3, a plurality of chips 10 may be packaged in a canister 30. FIGS. 2-3 are exemplary only. Other configurations of packing containers for chips 10 may also be utilized, as desired.

Preferably, the chip 10 is protein-rich, with the protein being provided in main part by salmon, cod, some combination thereof, or some other fish or beef protein source. Preferably, for improved nutritional value, the chips 10 are baked, though frying may be desired for some applications. It is also preferred, to the extent possible, to utilize organic ingredients. It is preferred, to the extent possible, to omit the use of preservatives, though this may be necessary for some applications.

In one embodiment, the chip 10 may be formed from the following ingredients: salmon and/or cod; flour; tomato paste, oil, green tea, lemon. In one embodiment, the preparation of a plurality of chips 10 proceeds as follows:

1. One cup of salmon and/or cod is shredded in a food processor;

2. The following ingredients, in the following quantities, may be mixed with the salmon/cod:

| Ingredient | Quantity |
|---|---|
| Whole wheat flour | 2 cups |
| Brown rice flour | 1.25 cups |
| Tomato paste | 1 teaspoon |
| Canola oil | 1 teaspoon |
| Green tea (containing spring water) | .5 cups |
| Lemon | One-half of one lemon |

3. The mixed ingredients form a dough, which may then be rolled out as thin as possible.

4. The dough is cut into round shapes with a cookie cutter type of cutting implement.

5. The raw chips are placed on a cookie sheet and into an oven that has been heated to approximately 275 degrees.

6. The chips are baked for ten minutes.

7. The oven is turned off.

8. The chips are turned over, and left in the oven for an additional 10 minutes.

9. The chips are removed to cool.

Preferably, each of the wheat flour, brown rice flower, tomato paste, canola oil, and green tea is organic.

It should be noted that additional ingredients may be added, such as additional flavorings, preservatives, etc. It should further be noted that substitutes may be found for certain of these ingredients, and further that it may be desired to eliminate certain of the listed ingredients entirely.

The quantities listed are approximations, and are more provided to show relative quantities rather than absolute ones. Thus, preparation of chips 10 in bulk will obviously require far larger quantities than those that are listed here.

Cooked chips 10 may be fed to canines as desired, and are particularly intended for use as snack items. Testing has shown that canines find chips 10 prepared in the manner described herein to be tasty and pleasing. They thus represent a convenient vehicle for providing to a canine a nutritious, protein rich snack that will actually be consumed.

I claim:

1. A method for providing a protein-rich food for a canine comprising:
forming a protein-rich food item, in combination with other ingredients, into a chip;
packaging a plurality of the chips in a container; and
providing at least one of the chips, from the container, to a canine.

2. The method of claim 1 wherein the protein-rich food item is salmon.

3. The method of claim 1 wherein the protein-rich food item is cod.

4. The method of claim 1 wherein the other ingredients are at least one of the following: flour; tomato paste, oil, green tea, lemon.

5. The method of claim 1 wherein the other ingredients include each of the following: flour; tomato paste, oil, green tea, lemon.

6. The method of claim 1 wherein the container is a bag.

7. The method of claim 1 wherein the container is a canister.

8. The method of claim 5 wherein each of these other ingredients is organic.

9. A method for providing a protein-rich food for a canine comprising;
forming a protein-rich food item, in combination with other ingredients, into a chip;
wherein the protein-rich food item is at least one of salmon and cod;
wherein the other ingredients are at least one of the following: flour; tomato paste, oil, green tea, lemon;
packaging a plurality of the chips in a container; and
providing at least one of the chips, from the container, to a canine.

10. The method of claim 9 wherein the other ingredients include each of the following: flour; tomato paste, oil, green tea, lemon.

11. The method of claim 9 wherein the container is a bag.

12. The method of claim 9 wherein the container is a canister.

13. The method of claim 10 wherein each of these other ingredients is organic.

14. A method for providing a protein-rich food for a canine comprising:
forming a protein-rich food item, in combination with other ingredients, into a chip;
wherein the protein-rich food item is at least one of salmon and cod;
wherein the other ingredients include each of the following: flour; tomato paste, oil, green tea, lemon;
wherein each of these other ingredients is organic;
packaging a plurality of the chips in a container;
wherein the container is one of a bag and a canister; and
providing at least one of the chips, from the container, to a canine.
